(19) United States
(12) Patent Application Publication
(10) Pub. No.: US 2026/0080728 A1
(43) Pub. Date: Mar. 19, 2026

(54) DATA COLLECTION DEVICE AND DATA COLLECTION METHOD

(71) Applicant: Komatsu Ltd., Tokyo (JP)

(72) Inventors: Sho Takeuchi, Tokyo (JP); Yoshitoshi Nagado, Tokyo (JP)

(73) Assignee: Komatsu Ltd., Tokyo (JP)

(21) Appl. No.: 19/107,066

(22) PCT Filed: Sep. 14, 2023
(86) PCT No.: PCT/JP2023/033548

§ 371 Date: Feb. 27, 2025

(30) Foreign Application Priority Data
Sep. 29, 2022 (JP) 2022-156041

(51) Int. Cl. G07C 5/08; G07C 5/00

(52) U.S. Cl. CPC G07C 5/0841; G07C 5/008

(57) ABSTRACT

A priority determination unit determines, in accordance with an event, priority of target operation data that is operation data related to the event. A writing unit stores the target operation data in a storage unit. In a case in which a capacity for recording the target operation data is insufficient, the writing unit overwrites operation data having relatively low priority among pieces of operation data stored in the storage unit with the target operation data. A transmission unit transmits operation data having relatively high priority among pieces of operation data stored in the storage unit to a management server with priority over operation data having relatively low priority.

### TECHNICAL FIELD

The present disclosure relates to a data collection device and a data collection method.

Priority is claimed on Japanese Patent Application No. 2022-156041, filed Sep. 29, 2022, the content of which is incorporated herein by reference.

### BACKGROUND ART

A technology of collecting and recording operation data of a vehicle in order to detect a sign of a failure of the vehicle is known (for example, refer to Patent Document 1).

### CITATION LIST

### Patent Document

Patent Document 1: Japanese Unexamined Patent Application, First Publication No. 2009-096337

### SUMMARY OF INVENTION

### Technical Problem

The operation data may be analyzed in a remote computer connected through a communication network such as the Internet. In this case, the recorded operation data is transmitted to a server device through the communication network. A work vehicle, such as a hydraulic excavator, may operate in a work site with a poor communication environment, and the capacity of a storage device for recording the operation data may be insufficient. In such a case, in a case in which old operation data is overwritten with new operation data, there is a concern that the operation data related to an important failure is overwritten and cannot be analyzed.

An object of the present disclosure is to provide a data collection device and a data collection method that prevent important operation data from being overwritten without being analyzed in a vehicle present in a site with a poor communication environment.

### Solution to Problem

A data collection device of an aspect of the present invention is a data collection device for being mounted in a vehicle, the data collection device including: an operation data acquisition unit configured to acquire operation data of the vehicle; an event detection unit configured to compare the operation data with a predetermined threshold value to detect an event related to an abnormality; a priority determination unit configured to determine, in accordance with the event, priority of target operation data that is the operation data related to the event; a writing unit, which is configured to store the target operation data in a storage unit, configured to overwrite, in a case in which capacity for recording the target operation data is insufficient, operation data having relatively low priority among pieces of operation data stored in the storage unit with the target operation data; and a transmission unit, which is configured to transmit the operation data recorded in the storage unit to a server device, configured to transmit operation data having relatively high priority among pieces of operation data stored in the storage unit to the server device with priority over operation data having relatively low priority.

### Advantageous Effects of Invention

According to the above-described aspect, the data collection device can prevent important operation data from being overwritten without being analyzed in a vehicle present in a site with a poor communication environment.

### BRIEF DESCRIPTION OF DRAWINGS

FIG. 1 A schematic diagram showing the configuration of a work machine according to a first embodiment.

FIG. 2 A schematic diagram showing the configuration of an engine system according to the first embodiment.

FIG. 3 A block diagram showing the configuration of a data collection device.

FIG. 4 A diagram showing an example of a condition table according to the first embodiment.

FIG. 5 A flowchart showing an operation data collection method according to the first embodiment.

### DESCRIPTION OF EMBODIMENTS

### First Embodiment

Hereinafter, an embodiment will be described in detail with reference to the drawings.

### <<Configuration of Work Machine 100>>

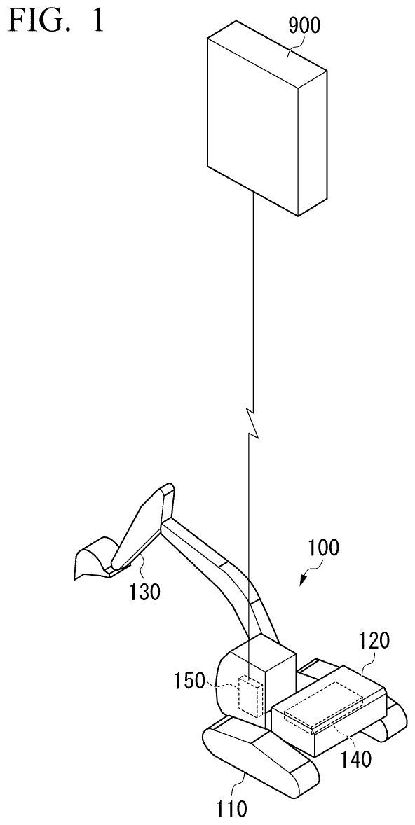

FIG. 1 is a schematic diagram showing the configuration of a work machine 100 according to a first embodiment. The work machine 100 operates at a construction site. Examples of the work machine 100 include a hydraulic excavator, a wheel loader, and a bulldozer. The work machine 100 may be driven by electric power or may be driven by hydraulic power. The work machine 100 includes an undercarriage 110, a vehicle body 120, work equipment 130, an engine system 140, and a data collection device 150.

The undercarriage 110 supports the work machine 100 such that the work machine 100 can travel. In the example shown in FIG. 1, the undercarriage 110 is configured of continuous tracks, but the travel body 110 may be configured of wheels. The vehicle body 120 is supported by the undercarriage 110. The vehicle body 120 may be provided to be capable of swinging on a swing center with respect to the undercarriage 110. The work equipment 130 is supported by a front portion of the vehicle body 120 to be drivable in an up-down direction.

### <<Configuration of Engine System 140>>

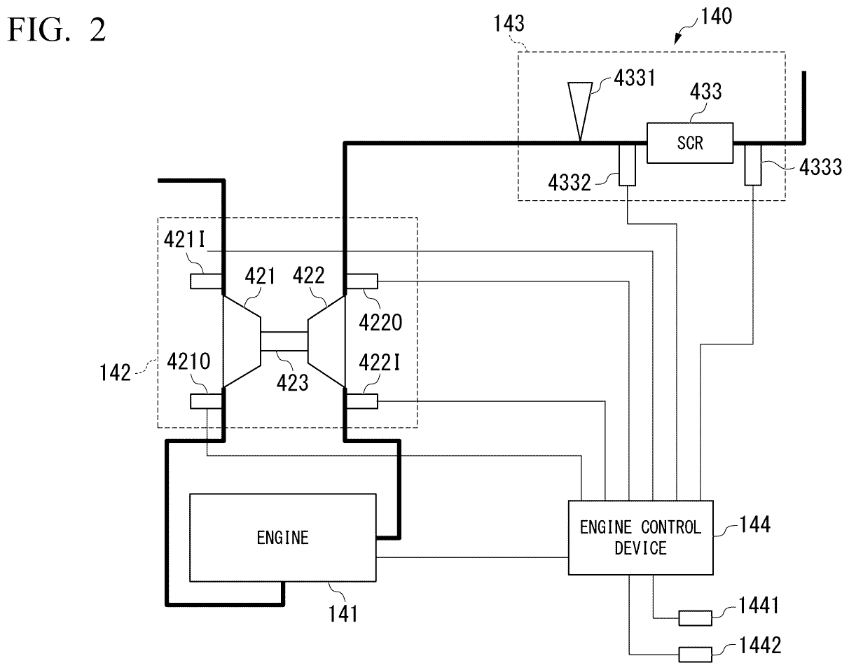

FIG. 2 is a schematic diagram showing the configuration of the engine system 140 according to the first embodiment.

The vehicle body 120 is provided with the engine system 140 that is a power source for the undercarriage 110 and the work equipment 130. The engine system 140 includes an engine 141, a turbocharger 142, an exhaust purification device 143, and an engine control device 144.

The engine 141 is a configuration example of an internal combustion engine and is a multi-cylinder diesel engine in the present embodiment. The turbocharger 142 is a supercharger that compresses intake air for the engine 141 by using exhaust of the engine 141.

The turbocharger 142 includes a compressor 421 that compresses taken-in air and supplies the compressed air to the engine 141, and a turbine 422 that is rotated by the exhaust of the engine 141. The compressor 421 and the turbine 422 are connected to a rotor 423 provided on the same rotation axis as those, and are rotated in conjunction with each other. The turbocharger 142 includes a compressor inlet sensor 421I that measures the pressure and the temperature at the inlet of the compressor 421, a compressor outlet sensor 421O that measures the pressure at the outlet of the compressor 421, a turbine inlet sensor 422I that measures the pressure and the temperature at the inlet of the turbine 422, and a turbine outlet sensor 422O that measures the pressure at the outlet of the turbine 422. In another embodiment, at least any one of the pressure at the inlet of the compressor 421, the temperature at the inlet of the compressor 421, the pressure at the inlet of the turbine 422, or the pressure and the temperature at the inlet of the turbine 422 may be obtained by calculation based on measured data of another sensor, internal data, or the like.

The exhaust purification device 143 purifies nitrogen oxide (NOx) contained in the exhaust of the engine 141. The exhaust is purified by the exhaust purification device 143 and then is discharged into the atmosphere.

The exhaust purification device 143 includes a selective catalytic reduction (SCR) 433.

The SCR 433 injects urea water into the exhaust to convert nitrogen oxide (NOx) into nitrogen molecules (N2) and water (H2O). The SCR 433 includes an injector 4331 that supplies urea water, an upstream NOx sensor 4332 that measures an NOx concentration in the exhaust upstream of the SCR 433, and a downstream NOx sensor 4333 that measures an NOx concentration in the exhaust downstream of the SCR 433.

The exhaust purification device 143 may include a diesel oxidation catalyst (DOC) and a diesel particulate filter (DPF), in addition to the SCR. The DOC oxidizes carbon monoxide in the exhaust to convert the carbon monoxide into carbon dioxide, oxidizes nitric oxide to convert the nitric oxide into nitrogen dioxide, and oxidizes hydrocarbon to convert the hydrocarbon into water and carbon dioxide. The DPF collects particulate matter (PM) contained in the exhaust and oxidizes the PM collected downstream by nitrogen dioxide converted by the DOC to convert the PM into carbon dioxide, thereby removing the PM.

The engine control device 144 repeatedly inputs measured data output from a plurality of sensors including the compressor inlet sensor 421I, the compressor outlet sensor 421O, the turbine inlet sensor 422I, the turbine outlet sensor 422O, the upstream NOx sensor 4332, and the downstream NOx sensor 4333 at a predetermined cycle, and performs fuel injection control of the engine 141 and the like.

The engine control device 144 is provided with an atmospheric pressure sensor 441 and an atmospheric temperature sensor 442. The work machine 100 may be used in a harsh environment such as an alpine region. On the other hand, in a low pressure environment, over-rotation due to a decrease in back pressure of the turbocharger 142 may occur. Therefore, ranges of the temperature and the altitude in which the engine system 140 can be used without any problem in practical use are determined as a specification of the engine system 140. The atmospheric pressure sensor 441 and the atmospheric temperature sensor 442 are provided to monitor the usage environment of the engine system 140. The engine control device 144 outputs the measured data of various sensors to the data collection device 150.

### <<Data Collection Device 150>>

The data collection device 150 collects the measured data of the sensors from a plurality of control devices of the work machine 100 including the engine control device 144, and records the measured data in an internal storage. Hereinafter, the measured data collected by the data collection device 150 will also be referred to as operation data. The operation data indicates the operation state of the work machine 100. The data collection device 150 is connected to a remote management server 900 through a network such as mobile communication or satellite communication. The management server 900 analyzes the operation data collected from each work machine 100 and diagnoses whether or not a failure of the work machine 100 has occurred or a sign of the failure.

The work machine 100 may be placed in a work site with a poor communication environment. Thus, the capacity of the storage may be insufficient before the transmission to the management server 900. Therefore, the data collection device 150 according to the first embodiment analyzes the operation data collected from the control device to determine whether the priority of the operation data is high or low, and reduces the possibility that the operation data having high priority is overwritten. In addition, the data collection device 150 transmits the operation data having high priority to the server 200 with priority over the operation data having low priority.

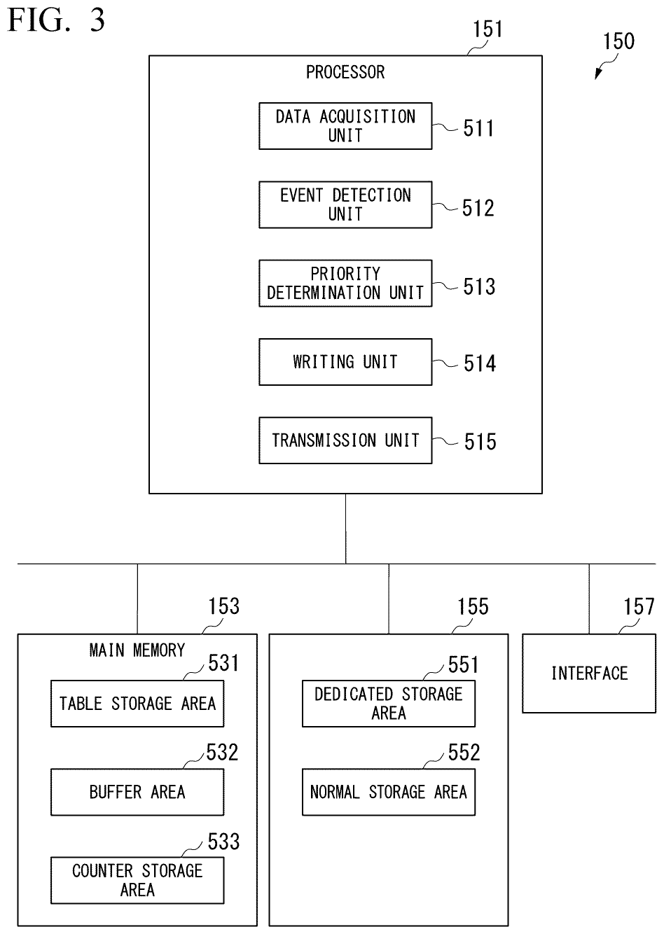

FIG. 3 is a block diagram showing the configuration of the data collection device 150.

The data collection device 150 is a computer including a processor 151, a main memory 153, a storage 155, and an interface 157.

The processor 151 reads out a program from the storage 155, loads the program into the main memory 153, and executes the above-described process in accordance with the program. In addition, the processor 151 secures, in the main memory 153, a storage area corresponding to each storage unit described above, in accordance with the program. Examples of the processor 151 include a central processing unit (CPU), a graphic processing unit (GPU), and a microprocessor.

The program may be for implementing a part of the functions that the data collection device 150 performs. For example, the program may make the functions in combination with another program already stored in the storage, or in combination with another program mounted in another device. In another embodiment, the data collection device 150 may include a custom large scale integrated circuit (LSI), such as a programmable logic device (PLD), in addition to or instead of the above-described configuration. Examples of the PLD include a programmable array logic (PAL), a generic array logic (GAL), a complex programmable logic device (CPLD), and a field programmable gate array (FPGA). In this case, a part or all of the functions implemented by the processor 151 may be implemented by the above-described integrated circuit. Such an integrated circuit is also included in an example of the processor.

Examples of the storage 155 include a magnetic disk, a magneto-optical disk, an optical disk, and a semiconductor memory. The storage 155 may be an internal medium directly connected to a bus of the data collection device 150, or may be an external medium connected to the data collection device 150 through the interface 157 or a communication line. In addition, in a case in which the program is distributed to the data collection device 150 through the communication line, the data collection device 150 that has received the distribution may load the program into the main memory 153 and execute the above-described process. In at least one embodiment, the storage 155 is a non-transitory tangible storage medium.

In addition, the program may be for implementing a part of the functions described above. Further, the program may be a so-called difference file (difference program) that implements the functions described above in combination with another program already stored in the storage 155.

The processor 151 execute the program to function as a data acquisition unit 511, an event detection unit 512, a priority determination unit 513, a writing unit 514, and a transmission unit 515. A dedicated storage area 551 and a normal storage area 552 for storing the operation data are secured in the storage 155. The dedicated storage area 551 is designed to have capacity sufficiently larger than a data amount of the operation data accumulated at a communication frequency assumed in a poor communication environment in which the work machine 100 is placed. A table storage area 531 that stores a condition table indicating relationships between the operation data and events, a buffer area 532 that temporarily stores the operation data, and a counter storage area 533 that stores the number of times of occurrence of each type of event are secured in the main memory 153. All of pieces of the operation data for a certain recent period are stored in the buffer area 532.

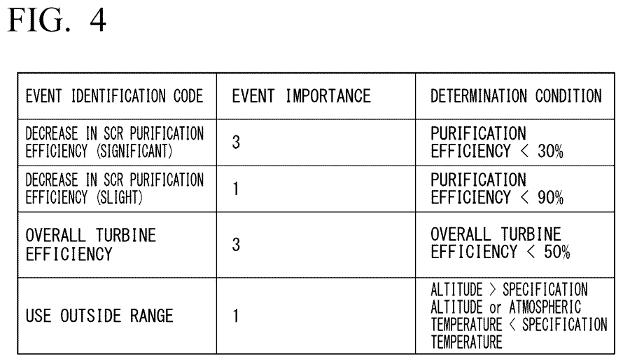

The table storage area 531 stores the condition table in which event identification codes, event importances, and determination conditions are associated with each other. FIG. 4 is a diagram showing an example of the condition table according to the first embodiment. The event identification code is an identifier indicating a type of the event related to the failure. Examples of the event include a slight decrease in the purification efficiency of the SCR 433, a significant decrease in the purification efficiency of the SCR 433, a decrease in the efficiency of the turbocharger 142, and use outside the specification range. The event importance is represented by an integer. The event importance is represented by, for example, a stage from 1 to 4. As the event importance is higher, a possibility of the failure of the work machine 100 is higher. The determination condition represents a relationship between an evaluation value for determining the occurrence of the associated event and a threshold value. The evaluation value may be the operation data itself or may be calculated from one or a plurality of pieces of the operation data.

The evaluation values related to the determination conditions shown in FIG. 4 will be described.

The purification efficiency that is the evaluation value the purification efficiency that is the evaluation value can be obtained by the ratio of the operation data of the downstream NOx sensor 4333 to the operation data of the upstream NOx sensor 4332.

The atmospheric temperature that is the evaluation value is the operation data of the atmospheric temperature sensor 442. The altitude that is the evaluation value is converted from the operation data of the atmospheric pressure sensor 441.

The overall turbine efficiency that is the evaluation value can be obtained from the following Expression (1).

$$η = \frac{{c}_{Pa} {T}_{C 1} \{ {{π}_{C}}^{( \frac{κ - 1}{κ} )} - 1 \}}{( 1 + \frac{1}{A / F} ) {c}_{Pg} {T}_{T 1} \{ 1 - {{π}_{T}}^{- ( \frac{κ - 1}{κ} )} \}} \qquad ( 1 )$$

η indicates the overall turbine efficiency that is the evaluation value. c_{Pa} indicates a constant pressure specific heat ratio of air, which is a constant. c_{Pg} indicates a constant pressure specific heat ratio of combustion gas, which is a constant. A/F indicates an air-fuel ratio. The air-fuel ratio is calculated by the ratio of the amount of air (the amount of oxygen) in a cylinder calculated from the pressure, the temperature, the EGR rate, and the like of an intake manifold to injected fuel. π_{c} is the compressor pressure ratio, and is obtained by the ratio of the measured data of the pressure by the compressor outlet sensor 421O to the measured data of the pressure by the compressor inlet sensor 421I. πᵣ is the turbine expansion ratio, and is obtained by the ratio of the measured data of the pressure by the turbine inlet sensor 422I to the measured data of the pressure by the turbine outlet sensor 422O. T_{T1} is the measured data of the temperature by the turbine inlet sensor 422I. T_{C1} is the measured data of the temperature by the compressor inlet sensor 421I.

The data acquisition unit 511 acquires the operation data from various control devices including the engine control device 144.

The event detection unit 512 determines whether or not the event has occurred based on the data acquired by the data acquisition unit 511 and the determination condition stored in the table storage area 531. In a case in which the occurrence of the event is detected, the event detection unit 512 specifies the importance and the number of times of occurrence of the event.

The priority determination unit 513 determines the priority of target operation data that is the operation data related to the detection of the event detected by the event detection unit 512, based on the importance and the number of times of occurrence of the event. The priority determination unit 513 determines the priority of the operation data related to the event whose importance is 3 or more as “high priority”. The priority determination unit 513 determines the priority of the operation data related to the event whose number of times of occurrence is 1 as “high priority”. The priority determination unit 513 determines the priority of the operation data related to the event whose importance is 2 or less and whose number of times of occurrence is 2 or more as “low priority”. The method of determining the priority according to another embodiment is not limited to the above-described method.

The target operation data is the operation data before and after a certain period from a timing at which the event detection unit 512 detects the occurrence of the event. The operation data before a certain period from the timing at which the occurrence of the event is detected is stored in the buffer area 532 of the main memory 153.

The writing unit 514 records the target operation data in the storage 155. In a case in which the priority determined by the priority determination unit 513 is “high priority”, the writing unit 514 records the target operation data in the dedicated storage area 551 of the storage 155. In a case in which the priority determined by the priority determination unit 513 is “low priority”, the writing unit 514 records the target operation data in the normal storage area 552 of the storage 155. In a case in which the capacity of the normal storage area 552 is insufficient in storing new target operation data, the writing unit 514 overwrites the oldest operation data with the new target operation data. Since the capacity of the dedicated storage area 551 is sufficiently secured as described above, the capacity less likely to be insufficient, but, in a case in which the capacity is insufficient, the writing unit 514 overwrites the oldest operation data with the new target operation data. In another embodiment, in a case in which the capacity of the dedicated storage area 551 is insufficient, the new target operation data may not be recorded, or the operation data related to the event with the lowest importance may be overwritten with the new target operation data.

The transmission unit 515 attempts to transmit the operation data to the management server 900 at a predetermined transmission cycle. The operation data transmitted by the transmission unit 515 may be deleted by the writing unit 514, or may be indicated that the deletion thereof is permitted by attaching a transmitted flag. In a case in which the operation data having “high priority” is recorded in the dedicated storage area 551, the transmission unit 515 may attempt to transmit the operation data without waiting for the transmission cycle. The operation data recorded in the dedicated storage area 551 is transmitted with priority over the operation data stored in the normal storage area 552. That is, the transmission unit 515 starts transmitting the operation data stored in the normal storage area 552 after all of pieces of the operation data recorded in the dedicated storage area 551 are transmitted.

### <<Operation Data Collection Method>>

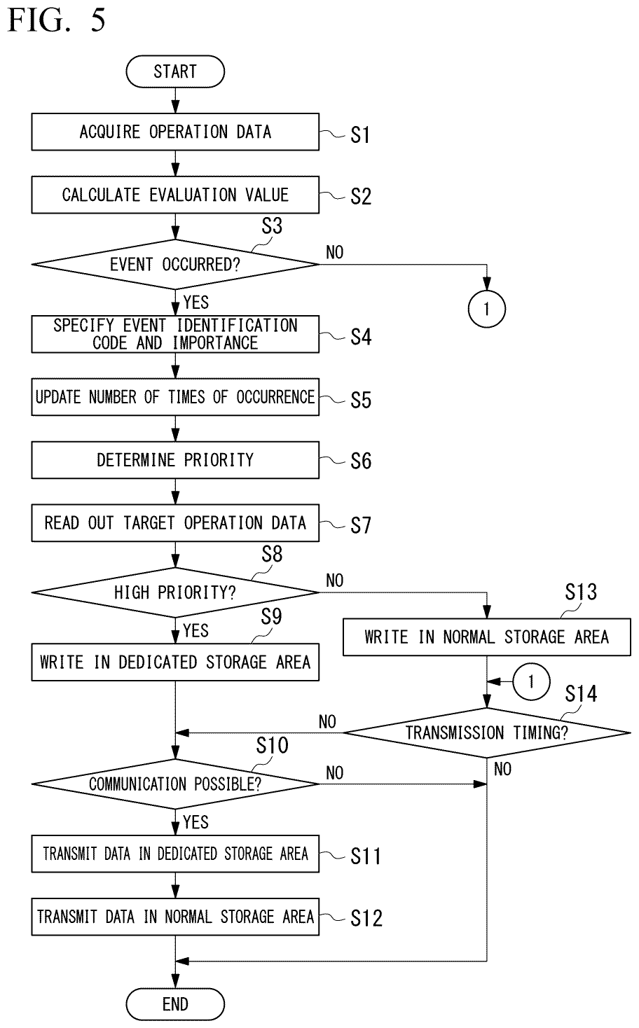

FIG. 5 is a flowchart showing an operation data collection method according to the first embodiment.

First, the data acquisition unit 511 acquires operation data from the control device (step S1). The event detection unit 512 refers to the determination conditions of the condition table stored in the table storage area 531, and obtains the evaluation values to be used to detect the event from the operation data (step S2). The event detection unit 512 determines whether or not the event has occurred for each event indicated by the condition table, based on the evaluation value obtained in step S2 (step S3). In a case in which the event is detected by the event detection unit 512 (step S3: YES), the event detection unit 512 specifies the event identification code and the event importance of the detected event (step S4). In addition, the event detection unit 512 updates the number of times of occurrence stored in the counter storage area 533 in association with the event identification code specified in step S4 (step S5).

The priority determination unit 513 determines the priority of the target operation data related to the event based on the specified event importance and number of times of occurrence (step S6).

The writing unit 514 reads out the type of the operation data used to detect the event from the buffer area as the target operation data (step S7).

The writing unit 514 determines whether or not the priority of the target operation data is high (step S8). In a case in which the priority is high (step S8: YES), the writing unit 514 writes the target operation data in the dedicated storage area 551 (step S9). The transmission unit 515 attempts to communicate with the management server 900 and determines whether or not the communication can be performed (step S10). In a case in which the communication with the management server 900 is successful (step S10: YES), the transmission unit 515 transmits the target operation data recorded in the dedicated storage area 551 to the management server 900 (step S11). Then, the transmission unit 515 transmits the target operation data recorded in the normal storage area 552 to the management server 900 (step S12).

On the other hand, in a case in which the priority is low (step S8: NO), the writing unit 514 writes the target operation data in the normal storage area 552 (step S13).

In a case in which the event is not detected by the event detection unit 512 in step S3 (step S3: NO), the operation data is not recorded in the storage 155.

In a case in which the event is not detected by the event detection unit 512 or in a case in which the target operation data is written in the normal storage area 552 in step S13, the transmission unit 515 determines whether or not a predetermined transmission timing has come (step S14). Examples of the transmission timing include a timing at which the work machine 100 is turned off, a predetermined time point, and the like. In a case in which the transmission timing has come (step S14: YES), the transmission unit 515 executes the process of step S10 and attempts to transmit the data that has not been transmitted. On the other hand, in a case in which the transmission timing has not come (step S14: NO), the transmission unit 515 does not attempt to transmit the data and retains the data.

### OPERATION AND EFFECT

As described above, the data collection device 150 according to the first embodiment includes the data acquisition unit 511, the event detection unit 512, the priority determination unit 513, the writing unit 514, and the transmission unit 515. Then, the data acquisition unit 511 acquires the operation data of the work machine 100. The event detection unit 512 compares the operation data with the predetermined threshold value to detect the event related to the abnormality. The priority determination unit 513 determines, in accordance with the event, the priority of the target operation data that is the operation data related to the event. The writing unit 514 stores the target operation data in the storage 155. In a case in which the capacity for recording the target operation data is insufficient, the writing unit 514 overwrites the operation data having relatively low priority among pieces of the operation data stored in the storage 155 with the target operation data. The transmission unit 515 transmits the operation data recorded in the storage 155 to the management server 900. The transmission unit 515 transmits the operation data having relatively high priority among pieces of the operation data stored in the storage 155 to the management server 900 with priority over the operation data having relatively low priority. As a result, the data collection device 150 according to the first embodiment can prevent important operation data from being overwritten without being analyzed by the management server 900 in the work machine 100 present at a site with a poor communication environment.

In addition, the writing unit 514 according to the first embodiment permits the deletion or the overwrite of the operation data that has been transmitted. As a result, the risk of the operation data that has not been transmitted of being overwritten can be reduced.

In addition, the event detection unit 512 according to the first embodiment specifies the type of the detected event, and specifies the importance and the number of times of occurrence of the event related to the type. In addition, the priority determination unit 513 determines the priority based on the importance and the number of times of occurrence. Specifically, the priority determination unit 513 determines the priority of the operation data related to the event whose importance is 3 or more or the operation data related to the event whose number of times of occurrence is the first time as “high priority”. As a result, it is possible to prevent the operation data related to the important event from being overwritten, and it is possible to prevent the data at the time of the first occurrence from being overwritten even in a case of the event having low importance. In another embodiment, the event detection unit 512 may specify the importance or the number of times of occurrence of the event, and the priority determination unit 513 may determine the priority based on the importance or the number of times of occurrence.

In addition, the target operation data according to the first embodiment is operation data related to before and after the occurrence timing of the event. As a result, the management server 900 can perform analysis using a state or an operation environment of the work machine 100 before and after the occurrence of the event.

In addition, the storage 155 according to the first embodiment includes the dedicated storage area 551 that is a first storage area and the normal storage area 552 that is a second storage area. The priority determination unit 513 determines the priority of the target operation data as either one of “high priority” or “low priority”. The writing unit 514 writes the operation data related to the “high priority” in the dedicated storage area 551 and writes the operation data related to the “low priority” in the normal storage area 552. In addition, in a case in which the capacity of the normal storage area 552 for recording the target operation data is insufficient, the writing unit 514 overwrites past operation data stored in the normal storage area 552 with the target operation data. As a result, the data collection device 150 can prevent the operation data having high priority recorded in the dedicated storage area 551 from being overwritten.

### ANOTHER EMBODIMENT

Although the embodiment has been described in detail with reference to the drawings, a specific configuration is not limited to the above-described configuration, and various design changes and the like can be made. That is, in another embodiment, the order of the processes described above may be changed as appropriate. Further, some processes may be executed in parallel.

The data collection device 150 according to the above-described embodiment may be configured of a single computer, or may be configured such that the configuration of the data collection device 150 is distributed to a plurality of computers and the plurality of computers cooperate with each other to function as the data collection device 150. For example, the control device, such as the engine control device 144, may have a part of the functions of the data collection device 150 (for example, the event detection unit 512, the priority determination unit 513, and the like).

In this case, a part of the computers constituting the data collection device 150 may be mounted in the work machine 100, and the other computers may be provided outside the work machine 100.

The data collection device 150 according to the above-described embodiment stores the operation data by dividing the storage area of the storage 155 in accordance with the priority, but the present invention is not limited to this. For example, the data collection device 150 according to another embodiment may be configured to store the priority in association with the operation data as metadata without dividing the storage area, and delete the operation data associated with the “low priority” in a case in which the capacity is insufficient.

### REFERENCE SIGNS LIST

100 Work machine
110 Undercarriage
120 Vehicle body
130 Work equipment
140 Engine system
141 Engine
142 Turbocharger
143 Exhaust purification device
144 Engine control device
150 Data collection device
151 Processor
153 Main memory
155 Storage
157 Interface
421 Compressor
421I Compressor inlet sensor
421O Compressor outlet sensor
422 Turbine
422I Turbine inlet sensor
422O Turbine outlet sensor
423 Rotor
431 DOC
432 DPF
433 SCR
4331 Injector
4332 Upstream NOx sensor
4333 Downstream NOx sensor
441 Atmospheric pressure sensor
442 Atmospheric temperature sensor
511 Data acquisition unit
512 Event detection unit
513 Priority determination unit
514 Writing unit
515 Transmission unit
531 Table storage area
551 Dedicated storage area
552 Normal storage area
900 Management server
532 Buffer area
533 Counter storage area

1. A data collection device for being mounted in a vehicle, the data collection device comprising:
a data acquisition unit configured to acquire operation data of the vehicle;
an event detection unit configured to compare the operation data with a predetermined threshold value to detect an event related to an abnormality;
a priority determination unit configured to determine, in accordance with the event, priority of target operation data that is the operation data related to the event;
a writing unit, which is configured to store the target operation data in a storage unit, configured to overwrite, in a case in which capacity for recording the target operation data is insufficient, operation data having relatively low priority among pieces of operation data stored in the storage unit with the target operation data; and
a transmission unit, which is configured to transmit the operation data recorded in the storage unit to a server device, configured to transmit operation data having relatively high priority among pieces of operation data stored in the storage unit to the server device with priority over operation data having relatively low priority.

2. The data collection device according to claim 1,
wherein the writing unit is configured to permit deletion or overwrite of the operation data that has been transmitted.

3. The data collection device according to claim 1,
wherein the event detection unit is configured to specify a type of the detected event and specify at least one of importance or the number of times of occurrence of the event related to the type, and
the priority determination unit is configured to determine the priority based on at least one of the importance or the number of times of occurrence.

4. The data collection device according to claim 1,
wherein the target operation data is operation data related to before and after an occurrence timing of the event.

5. The data collection device according to claim 1,
wherein the storage unit includes a first storage area and a second storage area,
the priority determination unit is configured to determine the priority of the target operation data as either one of high priority or low priority, and
the writing unit is configured to
write the operation data related to the high priority in the first storage area, write the operation data related to the low priority in the second storage area, and
overwrite, in a case in which capacity of the second storage area for recording the target operation data is insufficient, past operation data stored in the second storage area with the target operation data.

6. A data collection method comprising:
a step of acquiring operation data of a vehicle;
a step of comparing the operation data with a predetermined threshold value to detect an event related to an abnormality;
a step of determining, in accordance with the event, priority of target operation data that is the operation data related to the event;
a step of storing the target operation data in a storage unit;
a step of overwriting, in a case in which capacity of the storage unit for recording the target operation data is insufficient, operation data having relatively low priority among pieces of operation data stored in the storage unit with the target operation data; and
a step, which is for transmitting the operation data recorded in the storage unit to a server device, of transmitting operation data having relatively high priority among pieces of operation data stored in the storage unit to the server device with priority over operation data having relatively low priority.

7. The data collection device according to claim 2,
wherein the event detection unit is configured to specify a type of the detected event and specify at least one of importance or the number of times of occurrence of the event related to the type, and
the priority determination unit is configured to determine the priority based on at least one of the importance or the number of times of occurrence.

8. The data collection device according to claim 2,
wherein the target operation data is operation data related to before and after an occurrence timing of the event.

9. The data collection device according to claim 2,
wherein the storage unit includes a first storage area and a second storage area,
the priority determination unit is configured to determine the priority of the target operation data as either one of high priority or low priority, and
the writing unit is configured to
write the operation data related to the high priority in the first storage area, write the operation data related to the low priority in the second storage area, and
overwrite, in a case in which capacity of the second storage area for recording the target operation data is insufficient, past operation data stored in the second storage area with the target operation data.
